(19) United States
(12) Patent Application Publication
(10) Pub. No.: US 2026/0365396 A1
(43) Pub. Date: Nov. 19, 2026

(54) APPARATUS FOR PROTECTING CORNERS OF PACKAGED PRODUCTS

(71) Applicant: THE GARDNER GROUP LLC, SPRINGFIELD, MO (US)

(72) Inventors: KEVIN W. CYR, NOKOMIS, FL (US); JOEL R. OLSON, MENOMONIE, WI (US); RANDAL D. OLSON, LAKELAND, MN (US)

(21) Appl. No.: 19/679,979

(22) Filed: May 18, 2026

Related U.S. Application Data
(60) Provisional application No. 63/807,009, filed on May 16, 2025.

(51) Int. Cl. B65D 65/40; B31D 5/02; B65D 81/05

(52) U.S. Cl. CPC B65D 65/403; B31D 5/02; B65D 81/055

(57) ABSTRACT

Corner protectors 10 for packaging a product 500 in a container 300 are disclosed. The corner protectors 10 are manufactured from laminated corrugated fiberboard 400. The corner protectors 10 include a product receiving notch 12 and a strain relief 50 positioned in the product receiving notch 12 to avoid the transfer of forces to the product corners 502 of a product 500 secured in the container 600 by corner protectors 10.

### CROSS-REFERENCE TO RELATED APPLICATIONS

This application claims priority and benefit of U.S. Provisional Patent Application No. 63/807,009 filed 16 May 2025, which is hereby incorporated by reference in its entirety herein.

### BACKGROUND OF THE INVENTION

### Field of the Invention

The disclosure relates to packaging products for transport, warehousing and sale, more particularly, to corner protectors to reduce damage to corners of products.

### Background of the Art

Packaging materials, in various forms, have been an important part of shipping products since products were first boxed and shipped. Packaging materials, broadly expressed, include an external container and packaging inserts to secure the product within the container. As used herein, a container may take the form, for example, of crates, boxes, or other exterior packaging of various shapes, sizes and materials. Packaging inserts are designed to secure products within such containers. The inserts conform to various aspects of a product and engage the product to secure the product within the container. In doing so, the packaging inserts may protect products from damage resulting from impacts to, bending of, or penetration of the container during storage or transport. Corner protectors are a particularly important type of packaging insert as the corners of both the container and the internally packaged product tend to be vulnerable to damage from impacts with the ground and other objects.

Corner protectors are typically positioned over a product's corners or aspects of the product positioned near a corner of the container when the product is packaged. When packaged, this is between the product and an inside corner of the container. Generally, they are designed to mechanically secure and/or protect aspects of the packaged product near the corner of the container. When a product is packaged, one or more corner protectors, with only corner protectors or in combination with other types of packaging inserts, are used to support, stabilize and/or protect the packaged products. Corner protectors may do this by supporting and/or suspending the product at one or more of its corners at a desired position or range of positions within the container. For example, the internal packaging materials may be configured and placed at each end of the container to support the product within the box in such a manner that the product is held away from direct contact with the inner walls of the container. This protects the product from impacts, deformation and punctures of the container. The corner protectors may also function to absorb the force from impacts to the container.

The points where the edges of products come together to form points are particularly vulnerable to damage during shipping and warehousing. The damage to corners, even if minor, may result in the return of products merely for cosmetic damage. This is particularly troublesome in the furniture industry where items being shipped are relatively heavy. Many current corner protectors may adequately support the products and allow them to be shipped without problem but do not adequately protect the corners even from minor mishaps, such as drops. This has become a bigger issue with the modern requirements for use of sustainability of materials to replace expanded polystyrenes (EPS) which have dominated large sectors of the internal packaging market for decades. To facilitate the move to sustainable materials, new designs and configurations of packaging inserts will be necessary to overcome the differences and limitations of more materials such as corrugated fiberboard. One of the problematic areas is for corner protection of heavier items which are regularly damaged during transport and internal standardized. Accordingly, a need exists for improvements to insert designs made from sustainable materials to better protect corners from damage.

As eluded to in the prior paragraph, much of the currently available internal packaging materials are petroleum-based material. Such internal packaging materials represent a huge volume of petroleum-based material produced every year that is not biodegradable. This hinders companies in achieving sustainability goals and has been shown to have a negative impact on some customers' opinions of the manufacturer of these products. Looking at just the polystyrene, 14 million US tons is produced every year. It is estimated that about 54% of this is made into expanded polystyrene foam packaging. At an approximate density of 1 lb/ft³, the resulting foam, if placed in a layer three feet deep, would cover an area 13.5 miles long and 13.5 miles wide. The vast majority of this is placed into landfills and will take hundreds of thousands of years to chemically break down. Thus, we need to find sustainable alternatives.

Once discarded and over time, foam packaging materials mechanically breaks apart into smaller and smaller particles that may be carried away by wind and water. These particles frequently work their way into the food chain and add to the huge volumes of microplastics contaminating our planet and negatively impacting the biological systems of all creatures. Therefore, there is a need for the utilization of alternative materials for packaging inserts that are not only sustainable but recyclable and readily biodegradable.

Foam packaging is also delicate and may be easily broken when manufacturers are packaging their products. The broken foam packaging frequently goes unused by the manufacturer and is simply discarded. Such added waste packaging increases the costs of packaging the products to the manufacturer which costs are inevitably passed onto the consumer. The broken unused packaging is typically discarded which further taxes our landfills and damages the environment. Thus, a need exists for further utilization of packaging material that is more resistant to breakage during its manufacture and the packaging process. Packaging inserts utilizing such materials would be advantageous to both manufacturers and to the environment.

Although many petroleum-based foam materials are recyclable, these materials are not simply recyclable. In actual practice, only a small fraction of this material currently enters into the recycling process. With foams, this is, in part, because of the low density of the material and the difficulty in compacting it for efficient transport to a recycling facility. Of the fraction of petroleum-based materials entering the “recycling” system, a large volume of it is mixed together and practically inseparable. This undefined mix is placed into the vast world-wide stores of regrind and is generally considered commercially unusable. Therefore, a need exists for internal packaging materials that are not merely recyclable but are, in fact, actually recycled.

Other internal packaging materials include paperboard inserts are utilized to secure products within boxes. These are formed of cellulose-based materials which are recyclable and more frequently recycled. However, these paperboard inserts may be weak, complicated, time consuming, and, thus, expensive, to use for packaging. With heavy products, such paperboard internal packaging materials may be insufficient and tend to fail when placed in the stream of commerce so that polymeric foam discussed above is typically used for heavier products. In use, paperboard internal packaging materials are typically cut and folded to receive and secure the product within a box. The time and effort to package products with such paperboard inserts may increase the costs to the manufacturer that are passed through to consumers. Therefore, a need exists for a more robust, simpler system that may increase the efficiency of the packaging process while supporting heavier products.

Corrugated fiberboard is one the most highly recycled material on earth and, when configured correctly, has extraordinary strength. Corrugated fiberboard is cellulose based and typically uses starch-based adhesives. Thus, even if corrugated fiberboard is not recycled, corrugated fiberboard is readily biodegradable. Furthermore, corrugated fiberboard is a very strong material, particularly under compression along the axes of its flutes. However, corrugated fiberboard has limited flexibility for use in packaging application that require it to be configured in non-flat or three dimensional configurations, such as corner protectors. Corrugated fiberboard may not only be difficult to fold, but corrugated fiberboard may have a tendency to revert to its original unfolded state that may make the packaging process more difficult. Furthermore, the structural integrity of corrugated fiberboard may be compromised by the folding process, by tearing of the linerboards and/or the collapsing of the flutes, among other things, when folded. Accordingly, a need exists for packaging systems that may utilize the strength of corrugated fiberboard in packaging applications that are easily implemented and improve the utilization of corrugated fiberboards inherent strength and environmental impact.

To further improve sustainability of corrugated fiberboard used in packaging applications, designs that optimize the inherent characteristics of the corrugated fiberboard are needed. This includes utilizing its compressive strength supporting products along the axis of its flutes and its excellent shock absorbing characteristics when supporting products on the linerboard. Utilizing its compressive strength is critical in packaging and shipping heavy items. Utilizing its shock absorbing ability may be critical with the packaging of more delicate items.

These characteristics may be best utilized by laminated multiple layers of corrugated fiberboard. However, the cost of laminating and utilizing excessive amounts of corrugated fiberboard packaging may be cost prohibitive. Accordingly, a need exists for packaging designs that may maximize the desired characteristics for the application while reducing the amount of corrugated fiberboard required in packaging applications as well as simplifying and reducing the cost of manufacture.

### BRIEF SUMMARY OF THE INVENTION

These and other needs and disadvantages may be overcome by the apparatus and related methods disclosed herein. Additional improvements and advantages may be recognized by those of ordinary skill in the art upon study of the present disclosure.

The apparatus for packaging a product may have a corrugate laminate including a plurality of corrugated fiberboard sheets. The corrugate laminate may define a container receiving element and a product receiving notch. The container receiving element may include a first container engaging surface, a second container engaging surface, and a third container engaging surface configured to engage an inner corner of a container. The product receiving notch may include a first product contacting surface, a second product contacting surface and a third product contacting surface. The first product contacting surface, the second product contacting surface and the third product contacting surface may be oriented at substantially right angles. The first product contacting surface and the second product contacting surface meet at an intersection and may be configured to receive a product corner. The line formed at the intersection defines a corner receiving axis. The third product contacting surface includes a strain relief that extends through a plurality of layers of the corrugate laminate that define the third product contacting surface, and the strain relief is generally aligned with the intersection to position a corner of a product adjacent to the strain relief when the product is positioned in the product receiving notch. The strain relief sized and shaped to receive a product corner of a product upon a deformation of the corrugate laminate. The strain relief may be a passage through the corrugate laminate. The strain relief may alternatively be a cavity in the corrugate laminate.

The first container engaging surface, the second container engaging surface, and the third container engaging surface may be substantially planar in shape and oriented at right angles to one another to engage each of three inner container surfaces intersecting at a container corner.

The apparatus for packaging a product may be a corrugate laminate including an L-shaped portion and a base portion. The L-shaped portion may include a plurality of corrugated fiberboard sheets and the base portion may include a plurality of corrugated fiberboard sheets. The L-shaped portion may have a first product contacting surface and a second product contacting surface. The base portion may have a third product contacting surface. The first product contacting surface, the second contacting surface and the third product contacting surface may define a product receiving notch to receive a product corner. The base portion has a strain relief extending through at least the third product contacting surface. The strain relief is aligned with an intersection and extends into the base portion. The strain relief is configured to receive a product corner upon the deformation of the corrugated fiberboard sheets of the base portion.

A method for manufacturing multiple corner protectors at the same time may include the die cutting of a plurality of corrugated fiberboard sheets into a plurality L-shaped sections with each of the plurality of L-shaped sections linked to adjacent L-shaped sections. A plurality of corrugated fiberboard sheets are die cut into a plurality base sections with each of the plurality of base sections linked to adjacent base sections and each of the base sections and including a strain relief cut through the plurality of sheets. An adhesive is to a second linerboard of a first corrugated fiberboard sheet cut into a plurality of L-shaped sections. A second corrugated fiberboard sheet cut into the plurality of L-shaped sections is aligned with the first corrugated fiberboard sheet cut into the plurality of L-shaped sections. The second linerboard of the first corrugated fiberboard sheet is abutted with a third linerboard of the second corrugated fiberboard sheet. Adhesive is applied to a fourth linerboard of the second corrugated fiberboard sheet cut into the plurality of base sections. The second corrugated fiberboard sheet cut into the plurality of L-shaped sections is aligned with a third corrugated fiberboard sheet cut into the plurality of base sections. The fourth linerboard of the second corrugated fiberboard sheet is abutted with a fifth linerboard of the third corrugated fiberboard sheet. Adhesive is applied to a sixth linerboard of the third corrugated fiberboard sheet cut into the plurality of base sections. The third corrugated fiberboard sheet cut into the plurality of base sections is aligned with a fourth corrugated fiberboard sheet cut into the plurality of base sections. The sixth linerboard of the third corrugated fiberboard sheet is abutted with a seventh linerboard of the fourth corrugated fiberboard sheet. A compressive force is finally between the first linerboard of the first corrugated fiberboard sheet and an eighth linerboard of the fourth corrugated fiberboard sheet to facilitate bonding of the plurality of laminated corrugate sheets.

This brief summary of the invention is presented to provide a basic understanding of some aspects of the apparatus and methods disclosed herein as a prelude to the detailed description that follows below. Accordingly, this brief summary of the invention is not intended to identify key elements of the apparatus and methods disclosed herein or to delineate the scope thereof.

### BRIEF DESCRIPTION OF THE DRAWINGS

FIG. 1A illustrates a perspective view of a corner protector in accordance with aspects of the present invention;

FIG. 1B illustrates a perspective view of another side of the corner protector of FIG. 1B;

FIG. 2A illustrates a bottom view of an upper corner protector in accordance with aspects of the present invention;

FIG. 2B illustrates a side view of the corner protector as configured in FIG. 2A;

FIG. 2C illustrates a top view of the corner protector as configured in FIG. 2A;

FIG. 3 illustrates a top view of a corner protector in accordance with aspects of the present invention;

FIG. 4 illustrates a bottom view of a corner protector in accordance with aspects of the present invention;

FIG. 5 illustrates a perspective view of corner protectors being secured to an upper surface of a product positioned in a container in accordance with aspects of the present inventions;

FIG. 6A illustrates a partial cross-sectional view of an embodiment of a corner protector securing a product in accordance with aspects of the present invention prior to impact testing;

FIG. 6B illustrates a partial cross-sectional view of another embodiment of a corner protector positioned on a corner of a product in accordance with aspects of the present invention after impact testing;

FIG. 7 illustrates a perspective view of laminated corrugated fiberboard in accordance with aspects of the present invention;

FIG. 8 illustrates an exploded view of a corner protector showing the layers of corrugated fiberboard sheets in accordance with aspects of the present invention;

FIG. 9 illustrates an exploded view of a corner protector showing the layers of corrugated fiberboard sheets in accordance with aspects of the present invention;

FIG. 10 illustrates a top view of multiple corner protectors as linked during manufacture in accordance with aspects of the present invention;

FIG. 11A illustrates a perspective view of a two corner protectors linked together in accordance with aspects of the present invention; and

FIG. 11B illustrates a perspective view of a single corner protector unlinked from the two corner protectors of FIG. 1B in accordance with aspects of the present invention.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

The Figures generally illustrate exemplary implementations of corner protectors 10 made of laminated corrugated fiberboard for use in protecting and/or packaging products 500 for shipping and/or sale to customers. The particularly illustrated implementations of corner protector 10 have been chosen for ease of explanation and understanding of various aspects of the present inventions. There may be certain variations of the corner protectors 10 that may not be particularly illustrated in the Figures but are encompassed by the attached claims by having all the elements set forth in the claims and defined in the present document. The products 500 may be packaged using corner protectors 10 in containers 600 which may include boxes, crates, totes or other related containers. That said, the illustrated implementations are not meant to limit the scope of coverage but, instead, to assist in understanding the context of the language used in this specification and in the appended claims. Accordingly, the claims may encompass variations of corner protectors 10 and similar packing components that differ from the illustrated implementations.

The present inventions provide a corner protector 10 for securing packaged products 500 at one or more of their corners 502 to support and/or protect the product 500 within its external packaging, such as a container 600, during shipment, storage, display and/or consumer transport. The corner protector 10 may be configured to engage any of the inner corners 602 of container 600. These inner corners 602 may be formed at the intersection of one of the side surfaces, one of the front and back surfaces, and one of the top and bottom surfaces of the container 500. The corner protectors 10 are predominately manufactured from corrugated laminate 400. Corrugated laminate 400 includes two or more corrugated fiberboard sheets 410 which are laminated together with an adhesive to form the corrugated laminate 400. The corrugated laminate 400 includes multiple layers of corrugated fiberboard sheets 410 cut into various shapes that when laminated together will function as a corner protector 10 for packaging products 500. However, additional materials may also be included in the layers of corrugated laminate 400 to allow flexibility in design or strength of the corner protector 10 to meet product manufacturers' specifications. Corrugated fiberboard sheets 410 are recyclable and represent one of the most highly recycled materials in the world. Thus, a corner protector 10 made with corrugated fiberboard sheets 410 may provide a more sustainable solution for packaging than the plastics or petroleum based polymeric foams that are typically used to protect corners of products.

Corner protectors 10 may be formed by laminating two or more corrugated fiberboard sheets 410 to one another into a corrugated laminate 400. The corrugated fiberboard sheets 410 may be cut into desired shapes, such that when laminated together, for a corner protector 10 in accordance with the present inventions. In certain embodiments, the corrugated fiberboard sheets 410 containing repeated shapes linked to one another may be laminated to simultaneously produce multiple corner protectors 10. During lamination, each corrugated fiberboard sheet 410 is typically bonded to the adjacent corrugate fiberboard sheet 410 with an adhesive. A polyvinyl alcohol (PVA) based adhesive, for example, may be used as the adhesive due to its bonding characteristics and high level of compatibility with the corrugated fiberboard recycling processes. The specific PVA used may be selected for recyclability or otherwise selected as necessary for the end use of the corner protector 10.

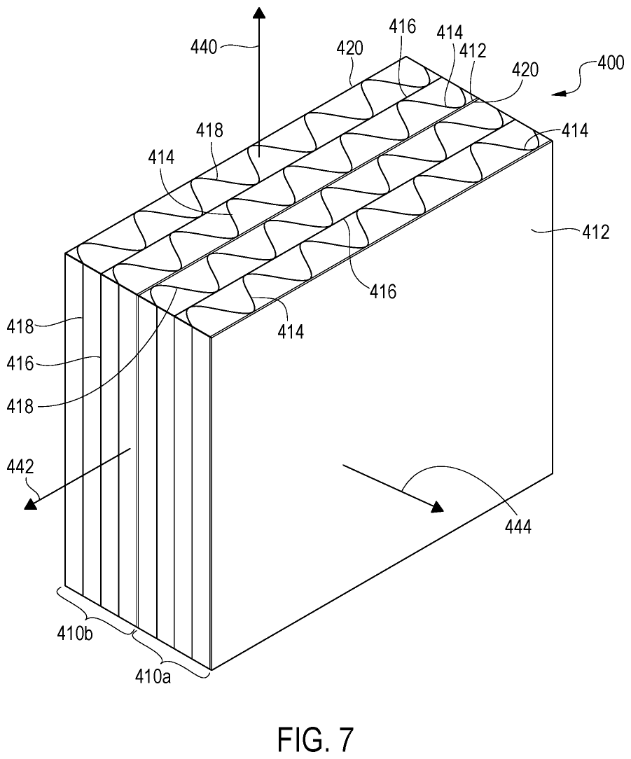

The corrugated laminate 400 is typically made from laminating multiple sheets of single wall, double wall and/or triple wall corrugated fiberboard sheets 410 by bonding the linerboards between the sheets of corrugated fiberboard. A partial section of corrugated laminate 400 is illustrated in FIG. 7. As illustrated, corrugated fiberboard sheets 410a, 410b are a double wall configuration. Each corrugated fiberboard sheet 410 in double wall configuration corrugated fiberboard sheet 410 includes five layers. A first outer linerboard 412 made of flat paperboard is bonded to a first flute layer 414. The first flute layer 414 is the wavy layer of the corrugated fiberboard sheets 410. A second middle linerboard 416 is formed from a flat paperboard that is bonded to the first flute layer on the opposite side as the first outer linerboard 412. A second flute layer 418 is bonded to the second middle linerboard 416 on the side opposite of the first flute layer 416. A third inner linerboard 420 is glued to the second flute layer completing the structure of a single sheet of double walled corrugated fiberboard. In accordance with aspects of the present inventions, a third inner linerboard 420 of a first corrugated fiberboard sheet 410a is bonded to the first outer linerboard 412 of a second corrugated fiberboard sheet 410b to form corrugated laminate 400. The waves of the first flute layer 416 and the second flute layer 418 form a columnar structure that adds strength and rigidity along the flute axis 440. Thus, when the flute axis 440 is configured as the predominant load bearing axis of a corner protector 10, the laminated corrugated fiberboard 400 has its greatest compressional strength. In another configuration of the corner protector 10, a flute perpendicular axis 442 may be the predominant load bearing axis of a corner protector 10. This orientation with forces, such as product weight, predominantly being supported along the flute perpendicular axis 442 typically provides an intermediate compressional strength for load bearing with the benefit of enhanced cushioning over the flute axis 440 as the predominant forces on the packaged product 500 and transmitted through the corner protectors 10 are transmitted along perpendicular to the columnar structure of the flutes. In yet another configuration of the corner protector 10, a linerboard perpendicular axis 444 may be the predominant load bearing axis of a corner protector 10. This orientation with forces, such as product weight, predominantly being supported along the linerboard perpendicular axis 444 typically provides the lowest compressional strength and rigidity for load bearing with the benefit of much enhanced cushioning over support along the flute axis 440 or the flute perpendicular axis 442 as the predominant forces on the packaged product 500 and transmitted through the corner protectors 10 are transmitted along perpendicular to the wavy structure of the flute layers 412, 418. The wave shape of the flute layers provides for substantial compliance (or cushioning) when forces are applied along the linerboard perpendicular axis 444. This cushioning ability of the corrugated laminate 400 is increased as additional corrugated fiberboard sheets 410 are added to the buildup of the laminated corrugated fiberboard 400.

Further, the flute axis 440 may be oriented in parallel orientations or in differing orientations between layers of adjacent corrugated fiberboard sheets 410 in the corrugate laminate 400 including, but not limited to, having perpendicular flute axis 440 in adjacent layers of corrugated fiberboard sheets 410. Further, the flute axis 440 may be at various angles to the edges of the fiberboard sheets 410 to allow for varying the strength and flexibility of the corrugate laminate 400 by altering desired orientations. This provides flexibility of design for various requirements of different packaging specifications.

A corner protector 10 formed from a corrugated laminate 400 and defines a product receiving notch 12 and a container engaging element 14. The product receiving notch 12 is formed from cooperation of the shapes of multiple layers of corrugated fiberboard sheets 410 when they are laminated together into the corrugated laminate 410. The product receiving notch 12 is generally defined by two or more corrugated fiberboard sheets 410 of the corrugated laminate 400 including surfaces that will face inward into toward the product 500 when received on a product corner 502 a packaged product 500. The product receiving notch 12 includes at least three surfaces that engage a product corner 502 of a product 500. In many applications, the three surfaces of the product receiving notch 12 will engage a side surface, a front or back surface and a top or bottom surface of the product 500. With some irregularly shaped products 500, the product receiving notch 12 may be alternatively configured within the scope of the present inventions to secure the corners 502 of products 500. The container engaging element 14 is generally defined by two or more corrugated fiberboard sheets 410 on a portion of the corner protector 10 that will face outward from the product 500 and toward the inner surfaces of the container 600 when secured on a product corner 502 a packaged product 500. The container engaging element 14 is configured to engage an inside corner 602 of a container 600 to support the product 500 at one of its corners 502 when the product 600 is packaged in the container 600.

The product receiving notch 12 may be formed by an L-shaped portion 13 of the corrugated fiberboard sheets 410 of the corrugated laminate 400 and a linerboard 412 of an adjacent corrugated fiberboard sheet 410 in a base portion 15 of the corrugate laminate 400. The portion of the corrugated laminate 400 including corrugated fiberboard sheets 410 with an L-shaped portion 13 may include one or more layers of corrugated fiberboard sheets 410. The L-shape portion 13 may include a first arm 22 and a second arm 24. Although generally illustrated as uniform in size and shape between the layers, the first arm 22 and the second arm 24 may be perpendicular to one another or may extend at other angles, be dissimilar in various aspects of their shapes or size, and/or include additional interlocking elements to better conform to and/or secure the product corner 502 of a product 500. The first arm 22 of the L-shaped corrugated fiberboard sheets 410 define a first product contacting surface 32 that will form a portion of the product receiving notch 12. The second arm 24 of the L-shaped corrugated fiberboard sheets 410 define a second product contacting surface 34. The first arm 22 and the second arm 24 contiguous with, connected to, or integral with one another to form or approximate the L-shape. The intersection 38 of the first product contacting surface 32 of the first arm 22 and the second product contacting surface 34 of the second arm 24 receives an edge 520 and a product corner 502 of product 500. A third product contacting surface 36 is formed by the face of a linerboard of the corrugated fiberboard sheet 410 laminated adjacent to the L-shaped portion of corrugated fiberboard sheets 410. This third product contacting surface 36 extends between at least a portion the first arm 22 and the second arm 24. The first product contacting surface 32, the second product contacting surface 34 and the third product contacting surface 36 are shown intersecting one another at substantially right angles. In combination, the first product contacting surface 32, the second product contacting surface 34 and the third product contacting surface 36 cooperate to form the product receiving notch 12. At least one corrugated fiberboard sheets 410 form each of first product contacting surface 32, the second product contacting surface 34 and the third product contacting surface 36 of the product receiving notch 12, in various implementations.

The first product contacting surface 32 and the second product contacting surface 34 may be formed by the edges of one or more layers of corrugated fiberboard sheets 410 of the corrugated laminate 400. The first product contacting surface 32 is configured to contact a portion of the first surface of the product 500. The second product contacting surface 32 is configured to contact a second surface of the product 500. In certain aspects, the first product contacting surface 32 and the second product contacting surface 34 may be perpendicular to one another to engage a first surface and a second surface of product 500 that are oriented perpendicular to one another or may be otherwise oriented with one another to permit the first product contacting surface 32 and the second product contacting surface 34 to engage with a packaged product 500 to support it within container 600. The first product contacting surface 32 may be planar or otherwise shaped to conform with or engage aspects of the first surface 532 of the product 500 to secure product 500 within a container 600. Similarly, the second product contacting surface 34 may be planar or otherwise shaped to conform with or engage aspects of the second surface 534 of the product 500 to secure product 500 within a container 600. Further, the first arm 22 and the second arm 24 may have the same shape or may be differentially shaped, between layers of the corrugated laminate 400 or between each other, to correspond to or better cooperate with aspects of the product 500 for purposes of securing the corner protector 10 to the product 500.

The corner protector's 10 configuration such as sizing, spacing, number of layers of corrugated fiberboard, the orientation of the flutes in adjacent layers of corrugated fiberboard sheets 410, the strength and type of corrugated fiberboard as well as the relative orientation of the first arm 22 and second arm 24 may vary depending on the particular product 500 being packaged and the manufacturer's requirements for packaging. Further, the first arm 22 and the second arm 24 may be generally the same length as illustrated in the figures but, in other embodiments, the first arm 22 and the second arm 24 may be different lengths and widths.

The container engaging element 14 of the corner protector 10 generally comprises the three outward facing surfaces configured to engage each of the three the inner surfaces adjacent to an inner corner 602 of the container 600. The container engaging element 14 is generally on the opposite side of the corrugated laminate 400 from the product receiving notch 12. The container engaging element 14 includes at least three surfaces: a first container engaging surface 42, a second container engaging surface 44 and a third container engaging surface 46. The container engaging element 14 secures the position of a product corner 502 relative to a corner 602 of the container 600. As illustrated, the first container engaging surface 42, the second container engaging surface 44, and the third container engaging surface 46 may be substantially planar in shape and oriented at right angles to one another to engage each of the three inner surfaces intersecting at a corner within first container engaging surface 42, a second container engaging surface 44, and a third container engaging surface 46. The first container engaging surface 42, the second container engaging surface 44, and the third container engaging surface 46 are each configured to engage one of the three inner surfaces intersecting at a corner within the container 600. The engagement is such that, when a corner protector 10 is secured in position between a product 500 and the inner surfaces of the container 600. However, with certain containers 600 with different shapes or other internal features at or near the corners, one or more of the first container engaging surface 42, the second container engaging surface 44, and the third container engaging surface 46 may be at different orientations to one another or include additional features to engage with the inner surfaces of the container at the container 500's corner.

A strain relief 50 is provided through one or more of the layers of corrugated fiberboard sheets 410 in the corrugated laminate 400 to mitigate potential damage to the corners 502 of product 500. The strain relief 50 is an inner void in the corrugated laminate 400. The strain relief 50 extends through at least the corrugated fiberboard sheet 410 of the corrugated laminate 400 forming the third product contacting surface 36. The strain relief 50 is generally configured such that the product corner 502 of a product 500 positioned in a corner protector 10 is positioned adjacent to or within strain relief 50. One or more inner walls within the corrugated laminate 400 define the void of strain relief 50. The one or more inner walls may form the strain relief 50 with a cross-sectional shape of a rectangle, a triangle, a circle or other cross-sectional shape. The strain relief 50 is generally designed to prevent damage to the product corner 502 of a product 500 if the packaged product 500 is dropped or otherwise impacted in a manner which deforms the corner protector 10. The strain relief 50 is positioned generally at the intersection of first product contacting surface 32 and second product contacting surface 34 adjacent to the product corner 502 such that the product corner 502 may extend into or otherwise move within the strain relief 50 upon deformation of the corner protector 10 and/or container 600 from an external force or dropping of the packaged product 500. That is, the product corner 502 is positioned such that when the packaged product 500 is subjected to external forces the corner may move into or about the void of the strain relief 50. As such, the product corner 502 avoids potentially damaging forces from being transmitted directly to the product corner 502 because the corner is able to move into or about the void of strain relief 50. This allows the product corner 502 to be displaced into or within the void of the strain relief 50 as the container 600 and/or the packaging insert 10 are deformed by external forces on the container 600. The positioning of the strain relief 50 prevents, or at least reduces the probability of the corners 502 of products 500 significantly engaging with the inner walls of the corner insert 10 and transferring forces exerted on the container 600 packaging product 500 to a product corner 502. This may happen when the product corner 502 directly engages a surface of the corner protector 10 if there were no strain relief 50. This is important because product corners 502 are typically vulnerable to damage because of the tendency to penetrate or otherwise interlock with the adjacent packaging and concentrate the forces. The strain relief 50 is generally configured to allow the product corner 502 to extend into the strain relief 50 with no or minimal contact with corrugate to eliminate or, at least, reduce the force transmitted through the corner protector 10 from an external force or dropping of the packaged product 500. Instead, the force may be distributed between the surfaces and edges of the product 500 which are in contact with the first product contacting surface 32, the second product contacting surface 34, the third product contacting surface 36, and their intersections. This may distribute the force of a drop or impact over a larger surface area and reduce the force on the product corner 502 which, without a strain relief 50, tend to penetrate or otherwise engage with one or more of the product contacting surfaces 32, 34, 36, particularly when the force applied is not tangential to one of the product contacting surfaces 32, 34, 36.

The strain relief 50 may be formed as a void in the corrugate laminate 400, may be formed as a cavity extending through some of the layers of corrugated laminate 400, or may be formed as a passage extending through all of the layers of corrugated laminate 400. Strain relief 50 may be positioned between the product 500 and the container 600 along the axis created by intersection 38, in certain embodiments, which may place the strain relief 50 directly over or under a corner of the product depending on whether the corner protector 10 is used for the top or the bottom, respectively, in packaging the product 500. Alternatively, the strain relief 50 may be configured such that the product corner 502 of the product 500 is positioned within the strain relief 50 when the associated product is packaged with a corner protector 10. The strain relief 50 may include one or more of a first inner wall 51, a second inner wall 53, a third inner wall 55, a fourth inner wall 57 depending upon the shape of the strain relief 50. A first inner wall 51 may be positioned a first offset distance 52 outward from the first product contacting surface 32 and a second inner wall 53 may be positioned a second distance 54 outward from the second product contacting surface 34. This may provide space for movement of the product's product corner 502 when it is positioned in the void of the strain relief 50 without contacting the inner walls 51, 53, 55, 57 of the strain relief 50. That is, when a product 500 is received in the product receiving notch 12, the strain relief 50 extends in one or more directions vertically outward and/or laterally outward toward the inner walls of container 600 from the corners 502 of product 500 to provide a void for the product corner 502 to move within should the container 600 and/or corner insert 10 be subject to forces from loading or impacts that deform the corner insert 10.

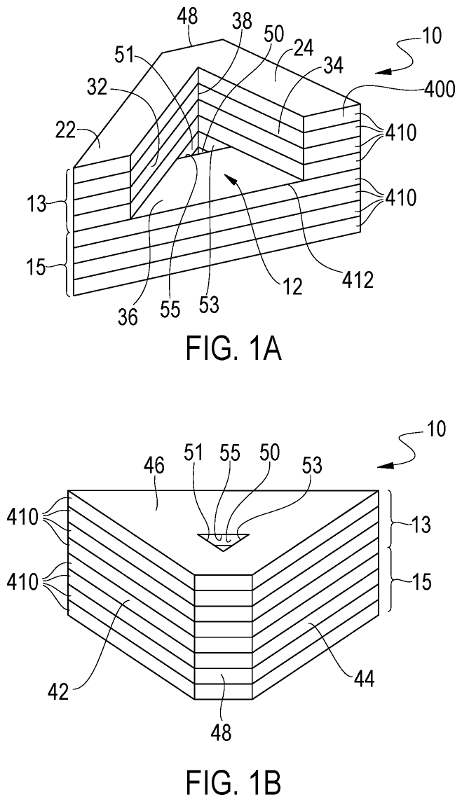

As particularly shown in FIG. 1A, a corner protector 10 may be formed from layers of corrugated fiberboard sheets 410 bonded into a corrugate laminate 400. As illustrated, the corner protector 10 is formed from eight (8) layers of corrugated fiberboard sheets 410. The top four corrugated fiberboard sheets 410 are in an L-shaped configuration and form the L-shaped portion 13 of the corner protector 10. The bottom four corrugated fiberboard sheets 410 are generally triangular in shape and form the base portion 15 of the corner protector 10. The first arms 22 form a substantially planar first product contacting surface 32 by the edges of the corrugated fiberboard sheets 410. The second arms 24 form a substantially planar second product contacting surface 34 at the inner of the edges at the corrugated fiberboard sheets 410. A first outer linerboard board 412 of the upper corrugated fiberboard sheet 410 of the base portion 15 forms the third product contacting surface 36. A product receiving notch 12 is formed by the first product contacting surface 32, the second product contacting surface 34 and the third product contacting surface 36. As illustrated, the product receiving notch 12 is generally shaped to receiving a product 500 having a product corner 502 formed by three generally planar surfaces coming together at right angles. The product receiving notch 12 has a strain relief 50 extending into and through the base portion 15. The strain relief 50 is a passage extending between the third product contacting surface 36 and the third container engaging surface 46, shown in FIG. 1B. The illustrated strain relief 50 generally has a triangular shape to permit the product corner 502 of a product 500 to enter the void defined by the strain relief 50 upon deformation of the corner protector 10. Thus, the strain relief 50 is positioned at the intersection 38 of the first product contacting surface 32 and the second product contacting surface 34 to allow a product corner 502 of the product 500 abutting these surfaces to move downward, as illustrated, through the strain relief 50 as the corner protector 10 deformed due to external forces places on the container 600 of a packaged product 500 and to avoid the transmission of forces to the product corner 502 to avoid damage to the product corner 502.

FIG. 1B illustrates a perspective view of the corner protector 10 of FIG. 1 rotated 180 degrees about a horizontal axis extending through figure on the plane of the drawing sheet. Each of the eight layers of corrugated fiberboard sheets 410 includes edge portions forming the first container engaging surface 42 and the second container engaging surface 44. The first container engaging surface 42 and the second container engaging surface 44 are formed as substantially planar and at substantially right angles to one another to engage the two of the inner walls at the corner 602 of a container 600. An outer linerboard 412 of the corrugated fiberboard sheet 410 at the top (as illustrated in the Figure) of the corrugate laminate 400 forms the third container engaging surface 46. The strain relief 50 is shown by the combination of FIGS. 1A and 1B continuing from the corrugate laminate 400 from the product contacting surface 36 through the third container engaging surface 46. A bevel 48 is also included between first container engaging surface 42 and the second container engaging surface 44 to provide a void between the inner walls of the container 600 and the corner protector 10 at along the edge leading to the corner 602. This bevel 48 may provide a buffer of space between the container 600 and the corner protector 10 to reduce the transfer of some container damaging forces from the container 600 to the product 500.

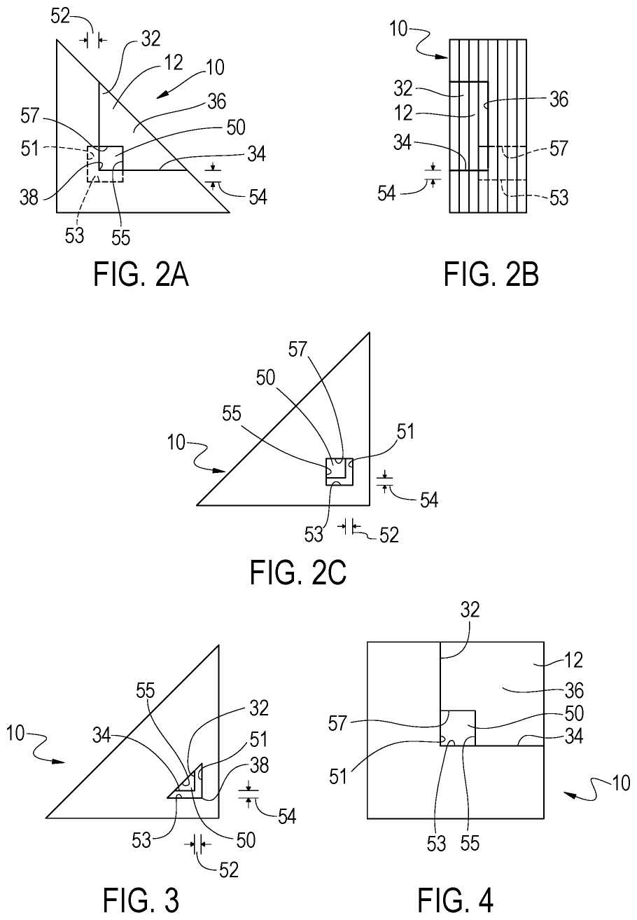

FIGS. 2A, 2B, and 2C illustrate features and structure of a corner protector 10 having an overall triangular shape. The product receiving notch 12 is formed by the combination of the first product contacting surface 32, the second product contacting surface 34 and the third product contacting surface 36, each of which is shown as substantially planar and positioned perpendicular relative to one another. The intersection 38 of the first product contacting surface 32 and the second product contacting surface 34 is configured to retain a product corner 502 of a product 500 and to position the product corner 502 above the void of the strain relief 50. The strain relief 50 has a square cross section and includes a first inner wall 51, a second inner wall 53, a third inner wall 55 and a fourth inner wall 57, in this implementation. The first inner wall 51 is offset from intersection 38 by a first offset distance 52 and the second inner wall 53 is offset from intersection 38 by a second offset distance 54. In this implementation, the offsetting of the first inner wall 51 and the second inner wall 53 by a first offset distance 52 and a second offset distance 54 positions the product corner 502 of the product 500 above or in the void, depending on shape and configuration of product 500 and corner protector 10, when the walls of the product are engaged with the first product contacting surface 32 and the second product contacting surface 34 when the product 500 is packaged in a container.

FIG. 3 illustrates a bottom view of a corner protector 10, similar to FIGS. 2A, 2B and 2C, having a strain relief 50 in the shape of a triangle. The intersection 38 of the first product contacting surface 32 and the second product contacting surface 34 is configured to retain a product corner 502 of a product 500 and to position the product corner 502 above the void of the strain relief 50. The illustrated strain relief 50 has a triangular cross section and includes a first inner wall 51, a second inner wall 53, and a third inner wall 55. The first inner wall 51 is offset from the intersection 38 by a first offset distance 52 and the second inner wall 53 is offset from the intersection 38 by a second offset distance 54. Again, the offsetting of the first inner wall 51 and the second inner wall 53 by a first offset distance 52 and a second offset distance 54 positions the product corner 502 of the product 500 above or in the void, depending on shape and configuration of product 500 and corner protector 10, when the walls of the product are engaged with the first product contacting surface 32 and the second product contacting surface 34 when the product 500 is packaged in a container.

FIG. 4 illustrates a bottom view of a corner protector 10 having an overall square shape. The intersection 38 of the first product contacting surface 32 and the second product contacting surface 34 is configured to retain a product corner 502 of a product 500 and to position the product corner 502 above the void of the strain relief 50. The strain relief 50 has a square cross section and includes a first inner wall 51, a second inner wall 53, a third inner wall 55 and a fourth inner wall 57. The plane of first inner wall 51 is with the plane of the first product contacting surface 32 and the plane of the second inner wall 53 is coincident with the second product contacting surface. The coplanar configuration of the first inner wall 51 and the second inner wall 53 with the first product contacting surface 32 and the second product contacting surface 34 positions the product corner 502 of the product 500 above or in the void, depending on shape and configuration of product 500 and corner protector 10, when the walls of the product are engaged with the first product contacting surface 32 and the second product contacting surface 34 when the product 500 is packaged in a container in accordance with the present invention.

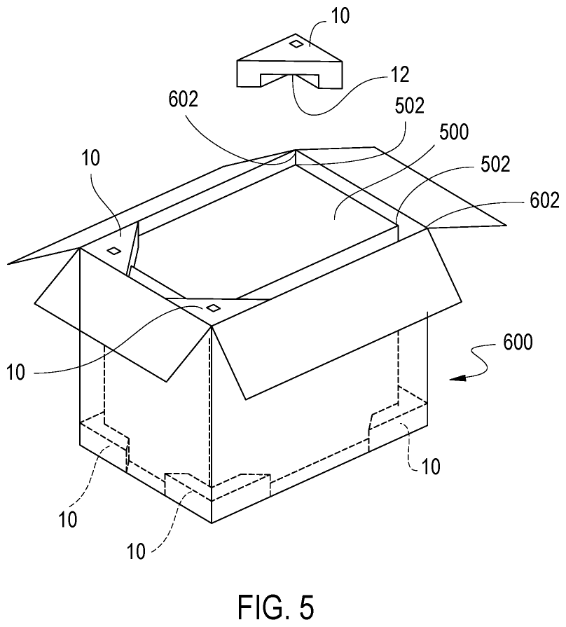

FIG. 5 shows a perspective view of a product 500 packaged within a container 600 using corner protectors 10 to secure the product 500 at its corners 502. As shown, eight (8) corner protectors 10 will be positioned to secure a product 500 at its corners 502 within the container 600. Three (3) corner protectors 10 are shown, in phantom, positioned on the bottom of the product 500 at each of its corners 502. The corner protectors 10 are positioned between the product corner 502 of the product 500 and the corner 602 of the container 600. Each of the corner protectors 10 shown at the bottom of the container 600 is secured between the inner walls of the container 600 at its corners 602 and the product 500. Two corner protectors 10 are shown positioned over the corners 502 of the product 500 on the top surface of the product between the inner walls of the container 600 at the left corners 602, as shown in the FIG. 5, of the container 600. A third corner insert 10 is shown positioned to be inserted on a third corner 602 of the product between the inner walls adjacent to the corner 602 of the container 600 and product corner 502 of the product 500. As illustrated, the corner protectors 10 are positioned with the third product contacting surface 36 of the corner protector 10 on either the top surface or bottom surface of the product 500. The corner protectors 10 may alternatively be positioned over the corners 502 of the product 500 in other orientations. That is, the corner protectors 10 may be positioned on the corners 502 of the product 500 with their third product contacting surface 36 alternative engaging any of the front, rear, left or right surfaces of the product 500 as shown in FIG. 5.

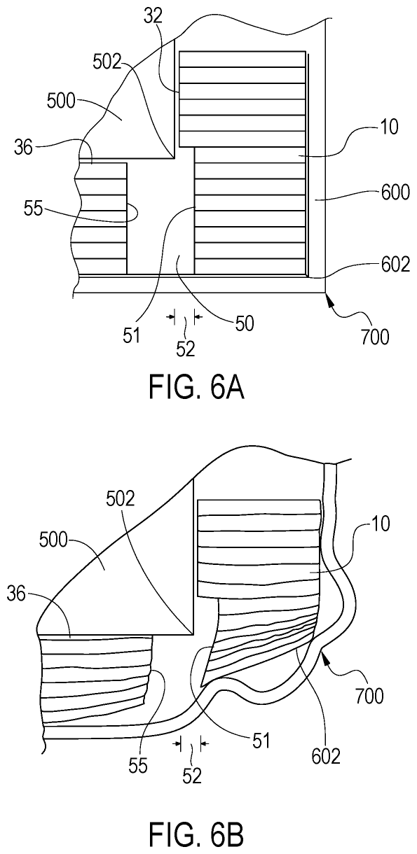

FIGS. 6A and 6B show a partial cross-sectional view of a product 500 having a corner protector 10 secured over a product corner 502 of the product 500. FIG. 6A shows the intact structurally intact container 600 and corner protector 10 before a damaging force 700 is applied to the outside corner 602 of the container 600. As shown, product corner 502 of the product 500 is positioned over a strain relief 50. The product corner 502 is spaced a first offset distance 52 from a first inner wall 51 within the strain relief 50 by abutting first product contacting surface 32. FIG. 6B shows a structurally damaged corner 602 of a container 600 and partially collapsed corner protector 10 after a damaging force 700 was applied to the outside corner 602 of the container 600. After receiving a damaging force 700, a likely result is the deformation and collapse of the corner 602 and the compression of multiple layers of laminated corrugated fiberboard 410 adjacent to the corner 602 to which a damaging force 700 is applied. In other implementations, the first inner wall 51 may be substantially coplanar with the first product contacting surface 32 to permit the product corner 502 to move into the strain relief 50 upon a force 700 being applied to the container 600. Thus, the strain relief 50 may prevent a damaging force from being conferred through the layers of the corrugated fiberboard 410 by allowing the product corner 502 to move into the strain relief 50 as the adjacent corrugated fiberboard 410 collapses. Instead of transferring forces to the product corner 502, the forces are transferred to the product through the first product contacting surface 32 and the third product contacting surface 36 adjacent to product corner 502 as the product corner 502 passes into the strain relief 50.

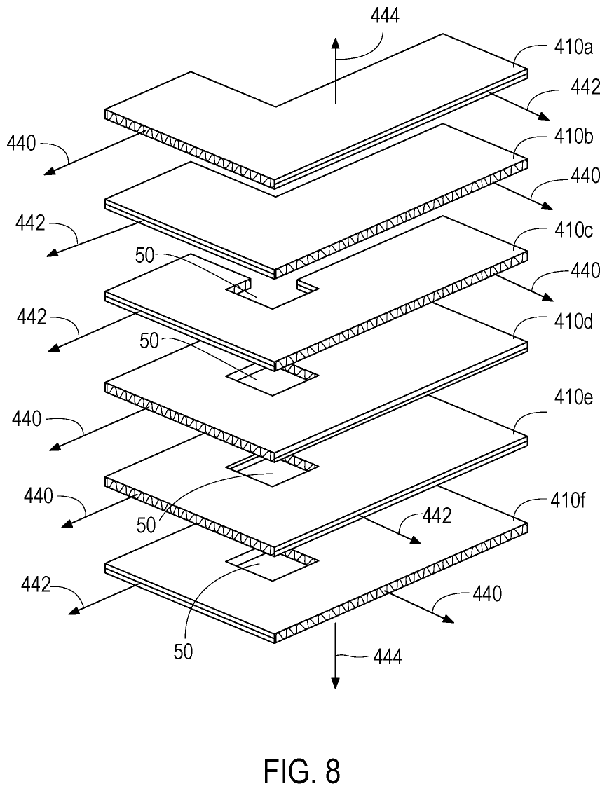

FIG. 8 illustrates an exploded perspective view of an embodiment of a corner protector 10 showing the layers, features and orientations of various layers of corrugated fiberboard sheets 410 of the corrugate laminate 400. FIG. 8 shows six layers of corrugated fiberboard sheets 410. The L-shaped portion 13 includes a first corrugated fiberboard sheet 410a, a second corrugated fiberboard sheet 410b, and a third corrugated fiberboard sheet 410c. The base portion 15 includes a fourth corrugated fiberboard sheet 410d, a fifth corrugated fiberboard sheet 410e, and a sixth corrugated fiberboard sheet 410f. As shown for exemplary purposes, the orientation of the flute axis 440 may vary between various layers of corrugated fiberboard 410. The third corrugated fiberboard sheet 410c in the L-shaped portion 13 defines a top portion of the strain relief 50. The fourth corrugated fiberboard sheet 410d, fifth corrugated fiberboard sheet 410e, and sixth corrugated fiberboard sheet 410f further define aspects of the strain relief 50. As shown the strain relief 50 is a passage extending through the base portion 15.

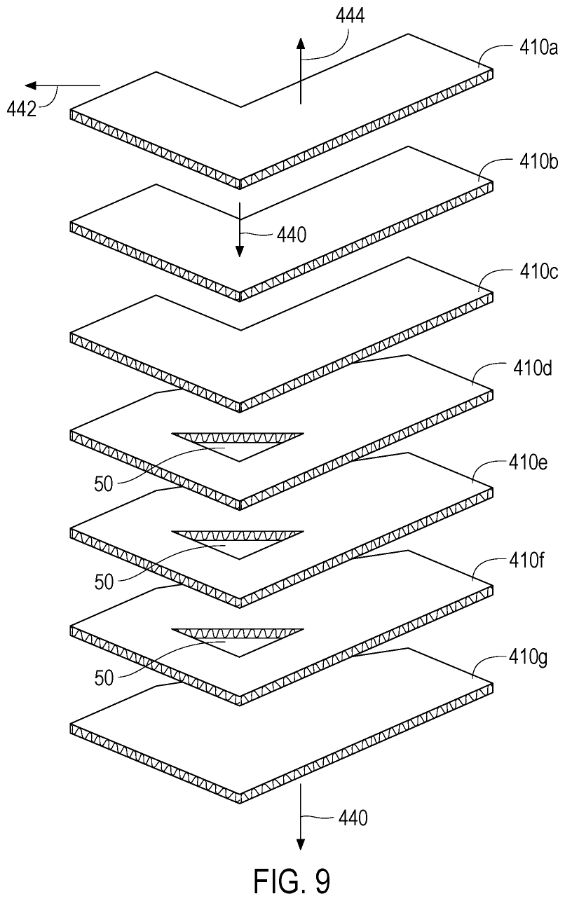

FIG. 9 illustrates another exploded perspective view of an embodiment of a corner protector 10 showing the layers, features and orientations of various layers of corrugated fiberboard sheets 410 of the corrugate laminate 400. FIG. 9 shows seven layers of corrugated fiberboard sheets 410. The L-shaped portion 13 includes a first corrugated fiberboard sheet 410a, a second corrugated fiberboard sheet 410b, and a third corrugated fiberboard sheet 410c. The base portion 15 includes a fourth corrugated fiberboard sheet 410d, a fifth corrugated fiberboard sheet 410e, a sixth corrugated fiberboard sheet 410f and a seventh corrugated fiberboard sheet 410g. As shown for exemplary purposes, the orientation of flute axis 440 may vary in orientation between various layers of corrugated fiberboard 410 and are generally shown on a diagonal orientation in the illustrated embodiment. The fourth corrugated fiberboard sheet 410d, fifth corrugated fiberboard sheet 410e, and sixth corrugated fiberboard sheet 410f further define aspects of the strain relief 50. The seventh corrugated sheet 410g does not include a portion of the strain relief 50. Accordingly as shown, strain relief 50 is a cavity in the base portion 15.

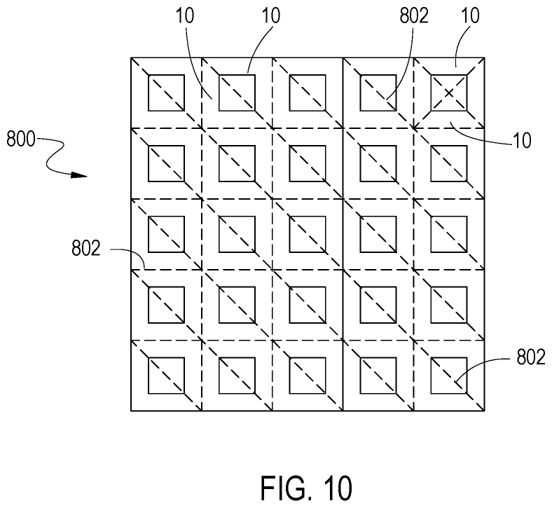

FIG. 10 shows an exemplary method for manufacturing a plurality of corner protectors 10. As illustrated, layers of corrugated fiberboard sheet 410 are laminated into a build-up 800 including a plurality of corner protectors 10. The particularly illustrated build-up 800 includes fifty linked corner protectors 10. Build-up 800 is formed by having each layer of corrugated fiberboard sheet 410 include the desired shape required for the particular layer cut into the corrugated fiberboard sheet 410. includes fifty linked corner protectors 10. Each layer includes links 802 of uncut portions of corrugated fiberboard, such as for example, perforations, that allow each layer of corrugated fiberboard sheet 410 to retain the fifty (50) corner protectors 10 on each corrugated fiberboard sheet 410 linked to one another and in the desired position during the laminating process. As such, each layer, up until the last layer, is run through a gluer to add glue to one surface of the corrugated fiberboard sheet 410. The next layer of corrugated fiberboard sheet 410 is glued and positioned such that the components on that sheet are aligned with the components of the prior corrugated fiberboard sheet 410. This is repeated until the last corrugated fiberboard sheet 410, which does not have a layer of glue, is positioned to align the components on that sheet with the components of the prior corrugated fiberboard sheet 410.

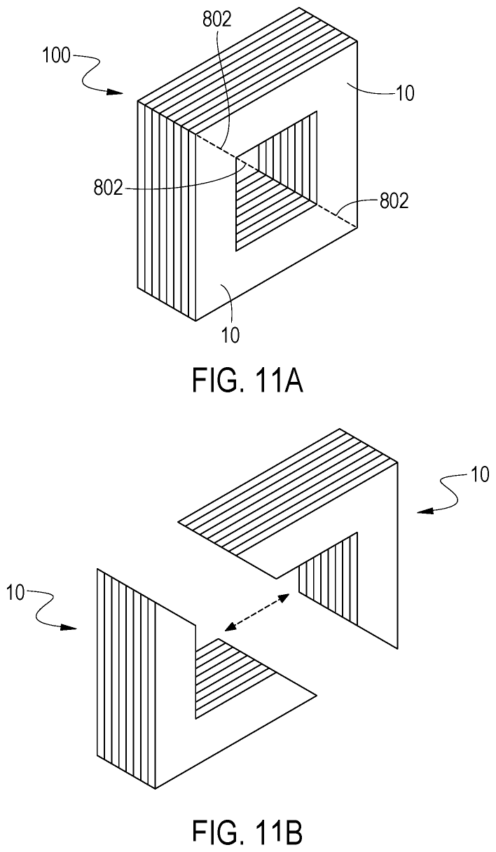

FIG. 11A illustrates a pair 100 of corner protectors 10 broken off from a build-up 800 of FIG. 10 and FIG. 11B illustrates the same pair of corner protectors 10 separated from one another at the links 802. The manufacturing of corner protectors 10 as linked units enables time and space efficient production, palletizing, transport, storage, and utilization by the end user.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations may be made thereto without departing from the spirit and scope of the inventions as defined in the following claims.

What is claimed is:

1. An apparatus for packaging a product, comprising:
a corrugate laminate comprising a plurality of corrugated fiberboard sheets;
a container engaging surface defined by the corrugate laminate to engage an inner corner of a container, the container engaging surface having a first container engaging surface, a second container engaging surface, and a third container engaging surface, each of the first container engaging surface, the second container surface, and the third container engaging surface configured to engage one inner surface three inner surfaces adjacent to the inner corner;
a product receiving notch defined by the corrugate laminate to receive a product corner of said product in order to secure said product within the container, the product receiving notch having a first product contacting surface, a second product contacting surface, and a third product contacting surface, the first product contacting surface and the second product contacting surface intersecting at an intersection;
a strain relief extending through a plurality of layers of the corrugate laminate defining the third product contacting surface and aligned with the intersection to position the strain relief adjacent to the product corner with the product corner external of the strain relief;
and wherein the strain relief is sized and shaped to receive insertably the product corner of said product upon deformation of the corrugate laminate.

2. The apparatus of claim 1, wherein the strain relief is formed as a passage through the corrugate laminate.

3. The apparatus of claim 1, wherein the strain relief is formed as a cavity in the corrugate laminate.

4. The apparatus of claim 1, wherein the first product contacting surface, the second product contacting surface, and the third product contacting surface are oriented at substantially right angles to one another.

5. The apparatus of claim 1, wherein wherein the first product contacting surface, the second product contacting surface, and the third product contacting surface are substantially planar in shape.

6. The apparatus of claim 1, wherein the first container engaging surface, the second container engaging surface, and the third container engaging surface are substantially planar in shape.

7. The apparatus of claim 1, wherein the first container engaging surface, the second container engaging surface, and the third container engaging surface are oriented at right angles to one another to engage each of three inner container surfaces at a container corner of a rectangular container.

8. The apparatus of claim 1, wherein every flute axis of every corrugated fiberboard sheet of the corrugate laminate is in parallel alignment and every flute perpendicular axis of every corrugated fiberboard sheet of the corrugate laminate is in parallel alignment.

9. The apparatus of claim 8, wherein the third product contacting surface is perpendicular to a flute axis of the corrugate laminate.

10. The apparatus of claim 8, wherein the third product contacting surface is perpendicular to a flute perpendicular axis of the corrugate laminate.

11. The apparatus of claim 8, wherein the third product contacting surface is perpendicular to a linerboard perpendicular axis of the corrugate laminate.

12. The apparatus of claim 1, wherein a surface selected from a group consisting of the first product contacting surface, the second product contacting surface, and the third product contacting surface is perpendicular to an axis of the corrugate laminate, the axis selected from a group consisting of a flute axis, a flute perpendicular axis, and a linerboard perpendicular axis.

13. An apparatus for protecting a corner of a product in a container, comprising:
a corrugate laminate including an L-shaped portion and a base portion, the L-shaped portion including a plurality of corrugated fiberboard sheets and the base portion including a plurality of corrugated fiberboard sheets, the L-shaped portion and the base portion having the L-shaped portion having a first product contacting surface and a second product contacting surface and the base portion having a third product contacting surface, the first product contacting surface, the second contacting surface and the third product contacting surface defining a product receiving notch to receive said corner of said product, the base portion having a strain relief extending through at least the third product contacting surface, the strain relief aligned with an intersection and extending into the base portion and configured to receive said corner upon the deformation of the corrugated fiberboard sheets of the base portion.

14. A method for manufacturing corner protectors, comprising:
die cutting a plurality of corrugated fiberboard sheets into a plurality L-shaped sections with each of the plurality of L-shaped sections linked to adjacent L-shaped sections;
die cutting a plurality of corrugated fiberboard sheets into a plurality base sections with each of the plurality of base sections linked to adjacent base sections and each of the base sections including a strain relief;
applying an adhesive to a second linerboard of a first corrugated fiberboard sheet cut into a plurality of L-shaped sections;
aligning a second corrugated fiberboard sheet cut into the plurality of L-shaped sections with the first corrugated fiberboard sheet cut into the plurality of L-shaped sections;
abutting the second linerboard of the first corrugated fiberboard sheet with a third linerboard of the second corrugated fiberboard sheet;
applying the adhesive to a fourth linerboard of the second corrugated fiberboard sheet cut into the plurality of base sections;
aligning the second corrugated fiberboard sheet cut into the plurality of L-shaped sections with a third corrugated fiberboard sheet cut into the plurality of base sections;
abutting the fourth linerboard of the second corrugated fiberboard sheet with a fifth linerboard of the third corrugated fiberboard sheet;
applying the adhesive to a sixth linerboard of the third corrugated fiberboard sheet cut into the plurality of base sections;
aligning the third corrugated fiberboard sheet cut into the plurality of base sections with a fourth corrugated fiberboard sheet cut into the plurality of base sections;
abutting the sixth linerboard of the third corrugated fiberboard sheet with a seventh linerboard of the fourth corrugated fiberboard sheet; and
applying a compressive force between the first linerboard of the first corrugated fiberboard sheet and an eighth linerboard of the fourth corrugated fiberboard sheet.
